(19) United States
(12) Patent Application Publication
(10) Pub. No.: US 2001/0039001 A1
(43) Pub. Date: Nov. 8, 2001

(54) THREE-DIMENSIONAL CARVING OBJECT

(76) Inventor: HO-HSIN LIAO, TAIPEI (TW)

Correspondence Address: BACON & THOMAS PLLC, 625 SLATERS LANE 4TH FLOOR, ALEXANDRIA, VA, 223141176

(21) Appl. No.: 09/323,910

(22) Filed: Jun. 2, 1999

(30) Foreign Application Priority Data
Jun. 6, 1998 (TW) 87208977

(51) Int. Cl. G09B 23/00

(52) U.S. Cl. 434/276

(57) ABSTRACT

The present invention relates to a three-dimensional carving object comprises two major parts, a first outer portion and a inner portion, wherein the first outer portion is positioned in the outer space of the inner portion. The first outer should be removed by a carving tool or resemble tools, then the inner portion can be revealed afterwards, the main idea here is that the users can detect where the inner portion is by coloring on its surface for instance.

### BACKGROUND OF THE INVENTION

The present invention relates to a three-dimensional carving object, in a purpose of skill learning, training from carving as well as for leisure purpose.

Arousing an interest of carvings for beginners is not an easy task, and even harder for child, because kids can not properly manage three-dimensional concept. Therefore they loose interest of learning at the very beginning. According to the U.S. Pat. No. 3,889,389, Orzel, Stanley P., 1973 discloses how to teach students to carve a link chain, however this method can only be used for simple geometry and this method can not teach students to manage three-dimensional concept. As for a teaching or entertaining purpose, it is necessary to design a simple medium that can easily be carved into an object.

### SUMMARY OF THE INVENTION

The present invention relates to a three-dimensional carving object comprises two major parts, a first outer portion and a inner portion, wherein the first outer portion is positioned in the outer space of the inner portion. The first outer portion should be removed by carving tool or resemble tools then the inner portion can be revealed afterwards.

It is should be known where the inner portion is when a user (for instance, a student) removes the first outer portion by a carving tool. The color of texture of the inner portion for instance is different from the first outer portion: or at least coating different color of the inner portion to show the difference between the inner portion and first outer portion; or the material of inner portion can be harder than the first outer portion; these designs are made to inform a user where inner portion is after removing the first outer portion.

An object of the present invention is to arouse an interest of carving and to learn carving skills through this carving medium.

Another object of the present invention is to guide the users to carve a prepared three-dimensional carving medium into an object.

Further object of the present invention is to simulate the carving interest and to manage three-dimensional concept in carving.

### DESCRIPTION OF THE DRAWINGS

FIG. 1 is a perspective view of the invention.

FIG. 2 is a perspective view of the invention where the first outer portion has been removed.

FIG. 3 is a perspective view of the invention removed the entire first outer portion and the inner portion remained.

FIG. 4 illustrates the distinguished portion of the first embodiment in sectional view.

FIG. 5 illustrates the distinguished portion of the second embodiment by using colored strips.

FIG. 6 illustrates the distinguished portion of the second embodiment by using the colored texture.

FIG. 7 illustrates the material of the inner portion is harder than that of the first outer portion in the embodiment.

FIG. 8 illustrates the multiple outer portions for another embodiment.

FIG. 9 illustrates the outlines applied in the present invention.

### THE PREFERRED EMBODIMENT IN DETAIL

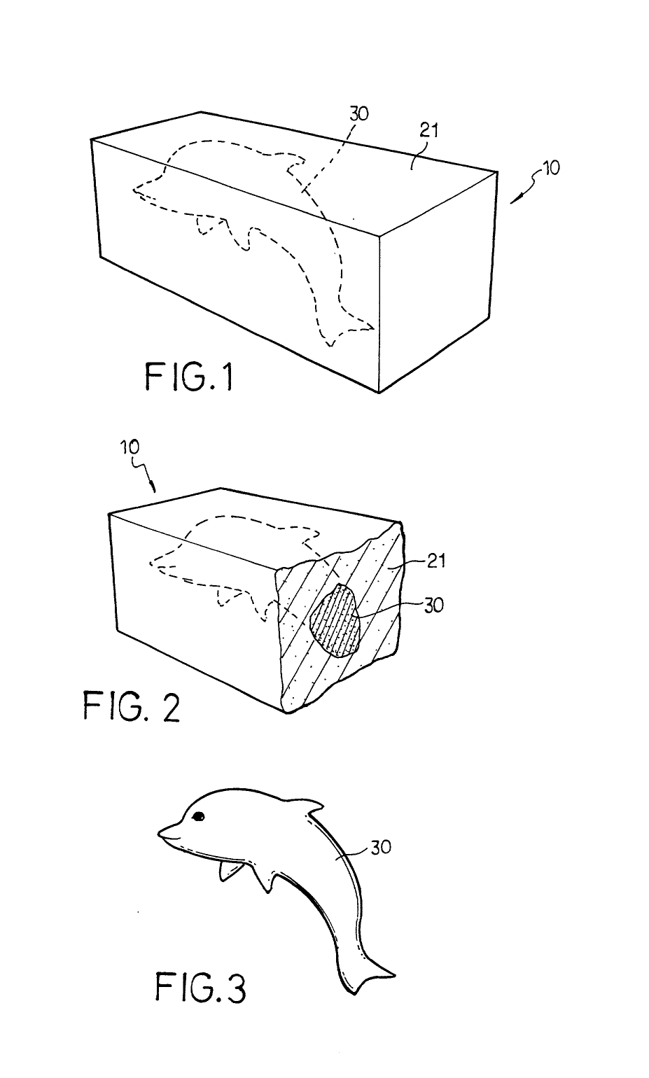

The first embodiment of the present invention is referred from FIG. 1 to 3. As illustrated in FIG. 1, the present invention of a three-dimensional carving object 10 comprises two major parts, a first outer portion 21 and a inner portion 30, wherein the first outer portion 21 is located on the surface of the inner portion 30. The inner portion 30 referred as a dolphin shape design in this embodiment will be revealed finally by cutting out the first outer portion with carving tools or resemble tools, thus the first outer portion 21 should be a substantial and solid material. Because the inner portion 30 is not necessary to be cut out, the inner portion 30 is only composed by solid material or composed by a hollow object with a shell outside of it.

As illustrated in FIG. 2, when a user removed the first outer portion 21 by carving tools, one should know where the inner portion 30 is. As in the first embodiment, user can be guided to where the inner portion is by such design in which the color of inner portion 30 is different from the color of the first outer portion. Therefore, the inner portion 30 can be obtained by completely cutting out the first outer portion 21 as shown on FIG. 3.

The methods can be varied as it used to be distinguished by colors; for instance, the first outer portion can be distinguished from the inner portion by means of different materials, colors and textures. Or by means of coating different color on the inner portion 30 referred as distinguished portion 50 in this description to distinguish the inner portion 30 from the first outer portion 21. The different embodiment of distinguished portion 50 hereinbelow:

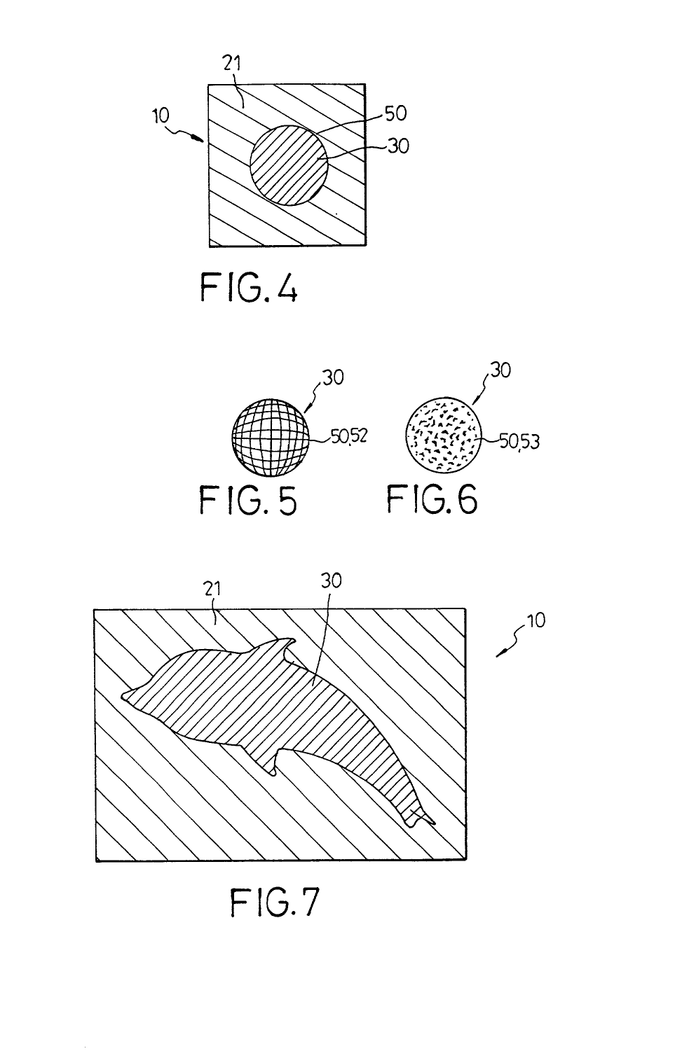

By using a ball to refer the inner portion 30 for instance, as seen in FIG. 4, distinguished portion 50 is located between first outer portion 21 and inner portion 30, and it can be layered on the surface of inner portion 30 by colors which is different from the one of first outer portion 21. This means distinguished portion 50 can be a colored layer 51. The other alternative way shown on FIG. 5 is that distinguished portion 50 can be coated by color strips referred as layer 52 or by color textures referred as layer 53 shown in FIG. 6, and both layers, etc. are located on the surface of inner portion 30. The main ideas of the embodiments hereinabove is to realize where the inner portion 30 is by using the color difference from a user's visual detection when the first outer portion 21 has the same material and color with the inner portion 30. In the meanwhile, coating color in all or partial manner on inner portion 30's surface results in the formation of distinguished portion 50. It also results from the colored material differed from first outer portion 21 and located in between the first outer portion 21 and inner portion 30, therefore the distinguished portion 50 should be thinner for instance, the first outer portion 21 and inner portion 30 is composed of wood, yet the distinguished portion 50 can be composed of resin.

In fact it is unnecessary in the presence of distinguished portion 50. If the material, color, and texture of first outer portion 21 and inner portion 30 differed from each other, the distinguished portion 50 should not be necessarily existed.

In addition to above, the material of inner portion 30 can be harder than first outer portion 21; in FIG. 7's case, user can determine inner portion 30 as a reason of hardness when the first outer portion is removed by carving tools.

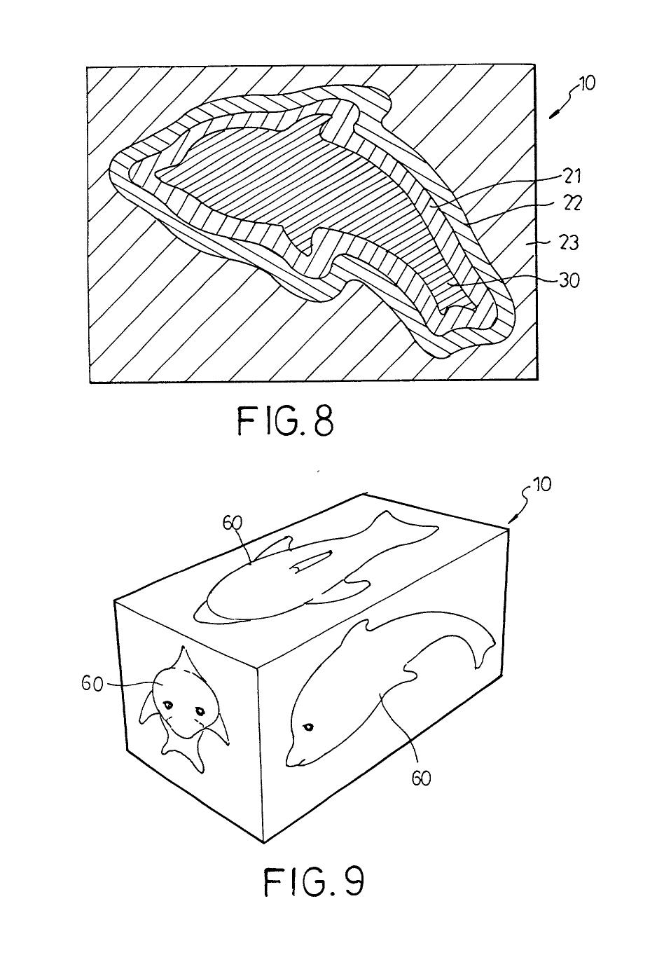

Moreover, it is indicated by FIG. 8, the first outer portion can be layered by other portions, for instance, a second outer portion 22 or a third outer portion 22. This design drawn under FIG. 8 is used for delicately reinforcing carving skills followed by cutting out the third outer portion 22, the second outer portion 22, and the first outer portion 21 consequently, it can be determined by the embodiment hereinabove whether the presence of distinguished portion 50 in between outer portions is necessary existed or not.

As illustrated in FIG. 9, for roughly understanding of the contour of the inner portion 30, outline 60 (e.g. showing the six views of the inner portion 30) is incorporated on the surface of a carving object, which is the outermost of the outer portion. A user can be further guided while one is carving.

Based on the traditional wooden carving material, it is suggested that the outer portion can be composed of wood. The inner portion 30 can be wood which is carved by man or by machine, or it can be composed of modeled wood (e.g. pressing wood power with chemical glue in a model to form a shape). The outer portion is suggested to be modeled by using wood power together with the pre-prepared inner portion 30. Thus a carving object 10 looks like wood as a whole. There are many other substances such as wax, which can be used for carving. The choice of materials may depend on various reasons, such as the age of a user. Furthermore, the color of materials for the outer portion can be transparent or non-transparent; as it chosen as transparent color, users such as under age 5 can determine inner portion 30 easily through the transparent color.

The above description is only an embodiment, the inner portion 30 can be in any shape and it is unnecessary that inner portion 30 has to be completely wrapped by the first outer portion 21; the distinguished portion 50 is not necessary to be colored, it can be formed by changing the color on the surface of inner portion 30 through chemical reaction, for instance, the color can be changed by using burning technique.

It is to be understood that the drawings are designed for purposes of illustration only, and are not intended as a definition of the limits and scope of the invention disclosed.

What is the claim is:

1. A three-dimensional carving object which can guide a user to carve, comprising:
a inner portion, which is a three-dimensional object;
a first outer portion positioned on the outer space of the inner portion, which is composed of solid material and can be carved; and
distinguished means for distinguishing said inner portion from said first outer portion to enable said user to know where said inner portion is when said user uses carving tools or resemble tools to remove of said first outer portion.

2. The three-dimensional carving object of claim 1, wherein the color of said first outer portion is non-transparent.

3. The three-dimensional carving object of claim 1, wherein said inner portion is composed by solid material.

4. The three-dimensional carving object of claim 1, wherein said inner portion is a hollow object with a shell outside of it.

5. The three-dimensional carving object of claim 1, wherein the material of said first outer portion and said inner portion is the same material.

6. The three-dimensional carving object of claim 1, further comprises outline(s) on the surface of said three-dimensional carving object.

7. The three-dimensional carving object of claim 1, wherein said distinguished means are to let the color of surface of said inner portion different from the color of said first outer portion.

8. The three-dimensional carving object of claim 1, wherein said distinguished means are to coat distinguishing color on the surface of said inner portion, and wherein said distinguishing color is different from the color of said first outer portion.

9. The three-dimensional carving object of claim 1, wherein said first outer portion is further layered by other “n” outer portion(s), “n” is the real numbers 1, 2, 3, etc., and said “n” outer portion(s) is(are) composed of solid material and can be carved.

10. A three-dimensional carving object which can guide a user to carve, comprising:
a inner portion, which is a three-dimensional object; and
a first outer portion positioned on the outer space of the inner portion, which is composed of solid material and can be carved;
wherein the material of said inner portion is harder than the material of said first outer portion, then said inner portion is able to be known and distinguished from said first outer portion by said user while one is using carving tools or resemble tools to remove said first portion.

11. A three-dimensional carving object which can guide a user to carve, comprising:
a inner portion, which is a three-dimensional object; and
a first outer portion positioned on the outer space of the inner portion, which is composed of solid material and can be carved;
wherein the color or the texture of the material of said inner portion is different from said first outer portion, then said inner portion is able to be known and distinguished from said first outer portion by user while one is using carving tools or resemble tools to remove said first portion.

12. The three-dimensional carving object of claim 11, wherein said first outer portion is further layered by other “n” outer portion(s), “n” is the real numbers 1, 2, 3, etc., and said “n” outer portion(s) is(are) composed of solid material and can be carved.

13. The three-dimensional carving object of claim 11, further comprises outline(s) on the surface of said three-dimensional carving object.

14. A three-dimensional carving object which can guide a user to carve, comprising:
a inner portion, which is a three-dimensional object; and
a first outer portion positioned on the outer space of the inner portion, which is composed of solid material and can be carved;
wherein the color or the texture of the surface of said inner portion is different from said first outer portion, then said inner portion is able to be known and distinguished from said first outer portion by user while one is using carving tools or resemble tools to remove said first portion.
